(19) United States
(12) Patent Application Publication
(10) Pub. No.: US 2026/0359244 A1
(43) Pub. Date: Nov. 12, 2026

(54) FIRMWARE PROGRAMMING METHOD, APPARATUS AND SYSTEM, MAINBOARD, DEVICE, AND STORAGE MEDIUM

(71) Applicant: SUZHOU METABRAIN INTELLIGENT TECHNOLOGY CO., LTD., Suzhou, Jiangsu (CN)

(72) Inventor: Huanchao WANG, Suzhou, Jiangsu (CN)

(21) Appl. No.: 19/140,451

(22) PCT Filed: Sep. 29, 2024
(86) PCT No.: PCT/CN2024/122313

§ 371 Date: Jun. 18, 2025

(30) Foreign Application Priority Data
Nov. 16, 2023 (CN) 202311531841.0

(51) Int. Cl. G06F 13/40

(52) U.S. Cl. CPC G06F 13/4022; G06F 2213/40

(57) ABSTRACT

A method for burning firmware is disclosed, including: switching a first line transfer switch of a motherboard to connect a communication transmission interface of the motherboard to a baseboard management controller memory of the motherboard, wherein the first line transfer switch is configured to switch connection of the baseboard management controller memory to a baseboard management controller, or connection of the baseboard management controller memory to the communication transmission interface; burning a firmware file into the baseboard management controller memory through the communication transmission interface and the first line transfer switch; and switching the first line transfer switch to connect the baseboard management controller to the baseboard management controller memory, so that the baseboard management controller calls the firmware file in the baseboard management controller memory. The baseboard management controller memory may be directly burned through the communication transmission interface of the baseboard management controller, avoiding disassembly of the baseboard management controller memory and reducing time and labor costs of repairing the baseboard management controller memory to a certain extent.

### CROSS-REFERENCE TO RELATED APPLICATION

This application claims the priority of the Chinese Patent application filed on Nov. 16, 2023 before the CNIPA, China National Intellectual Property Administration with the application number of 202311531841.0, and the title of “METHOD FOR BURNING FIRMWARE, MOTHERBOARD, APPARATUS, DEVICE, SYSTEM, AND STORAGE MEDIUM”, which is incorporated herein in its entirety by reference.

### FIELD

The present application relates to the technical field of data communications and more particularly, to a method for burning firmware, a motherboard, an apparatus, a device, a system, and a storage medium.

### BACKGROUND

With the increasing demand for server management and maintenance, more and more Baseboard Management Controllers (BMCs) have been applied in servers. In the later stage of server product development and after the mass production of servers, the baseboard management controllers, Basic Input Output Systems (BIOSs) inside the servers, and Complex Programmable Logic Devices (CPLDs) are all burned on line through firmware burning functions in BMC WEB. When BMC firmware is damaged or upgrade of BMC firmware fails and cannot be rolled back, the baseboard management controller cannot be used normally, thereby affecting the normal operation of the server.

In related art, the baseboard management controller is mainly burned by disassembling and repairing the board. Memory components of the baseboard management controller are first disassembled from the motherboard and then burned with a burning tool, and the burned memory components are re-soldered back to the motherboard to complete the repair.

However, in the above method, the disassembling and re-soldering of the memory components require high time and labor costs.

### SUMMARY

The embodiments of the present application aim at providing a method for burning firmware, a motherboard, an apparatus, a device, a system, and a storage medium, which may solve the problem of high maintenance time and labor costs when memory components of a baseboard management controller cannot be burned on line in related art.

In a first aspect, some embodiments of the present application provide a method for burning firmware, the method including:
switching a first line transfer switch of a motherboard to connect a communication transmission interface of the motherboard to a baseboard management controller memory of the motherboard, wherein the first line transfer switch is configured to switch between connection of the baseboard management controller memory to a baseboard management controller and connection of the baseboard management controller memory to the communication transmission interface;
burning a firmware file into the baseboard management controller memory through the communication transmission interface and the first line transfer switch; and
switching the first line transfer switch to connect the baseboard management controller to the baseboard management controller memory, so that the baseboard management controller calls the firmware file in the baseboard management controller memory.

In some embodiments, a second line transfer switch is provided on a connection line between the communication transmission interface and the baseboard management controller memory, and the switching a first line transfer switch of a motherboard to connect a communication transmission interface of the motherboard to a baseboard management controller memory of the motherboard includes:
switching the second line transfer switch of the motherboard to connect the communication transmission interface to the first line transfer switch, wherein the second line transfer switch is configured to switch connection of the communication transmission interface to the baseboard management controller, or connection of the communication transmission interface to the first line transfer switch; and
switching the first line transfer switch to connect the baseboard management controller memory to the second line transfer switch, wherein the first line transfer switch is configured to switch the connection of the baseboard management controller memory to the baseboard management controller, or connection of the baseboard management controller memory to the second line transfer switch.

In some embodiments, a second line transfer switch is provided on a connection line between the communication transmission interface and the baseboard management controller memory, and the switching the first line transfer switch to connect the baseboard management controller to the baseboard management controller memory includes:
switching the second line transfer switch to connect the communication transmission interface to the baseboard management controller, wherein the second line transfer switch is configured to switch connection of the communication transmission interface to the baseboard management controller, or connection of the communication transmission interface to the first line transfer switch; and
switching the first line transfer switch to connect the baseboard management controller memory to the baseboard management controller, wherein the first line transfer switch is configured to switch the connection of the baseboard management controller memory to the baseboard management controller, or connection of the baseboard management controller memory to the second line transfer switch.

In some embodiments, the method further includes:
turning off a first switch corresponding to a first power supply, wherein the first power supply and the first switch are located on the motherboard, and the first power supply is configured to supply power to the baseboard management controller and the baseboard management controller memory through the first switch; and
turning on a second switch of the motherboard, wherein the second switch is configured to allow an external power supply to supply power to the baseboard management controller memory through the communication transmission interface.

In some embodiments, the method further includes:
in response to the first line transfer switch connecting the baseboard management controller memory to the second line transfer switch, sending a first indicator signal to the baseboard management controller, wherein the first indicator signal is configured to turn on a red indicator lamp corresponding to the baseboard management controller.

In some embodiments, the sending a first indicator signal to the baseboard management controller includes:
obtaining a connection state of the second line transfer switch; and
in response to the connection state indicating that the second line transfer switch connects the communication transmission interface to the first line transfer switch, sending the first indicator signal to the baseboard management controller.

In some embodiments, the switching the first line transfer switch to connect the baseboard management controller to the baseboard management controller memory includes:
switching the first line transfer switch to connect the baseboard management controller to the baseboard management controller memory;
sending a second indicator signal to the baseboard management controller, wherein the second indicator signal is configured to turn off a red indicator lamp corresponding to the baseboard management controller.

In some embodiments, the burning a firmware file into the baseboard management controller memory through the communication transmission interface and the first line transfer switch includes:
displaying first switching information of the first line transfer switch, wherein the first switching information is configured to prompt a user to connect a burner for the firmware file to the communication transmission interface; and
in response to connection of the burner to the communication transmission interface, burning the firmware file into the baseboard management controller memory through the communication transmission interface and the first line transfer switch.

In some embodiments, the burning a firmware file into the baseboard management controller memory through the communication transmission interface and the first line transfer switch includes:
performing format conversion on the firmware file to obtain a programming file corresponding to the firmware file; and
burning the programming file into the baseboard management controller memory through the communication transmission interface and the first line transfer switch.

In a second aspect, some embodiments of the present application provide a motherboard, the motherboard including:
a baseboard management controller memory, a first line transfer switch, a communication transmission interface, and a baseboard management controller, wherein the first line transfer switch is configured to connect the communication transmission
interface, the baseboard management controller, and the baseboard management controller memory.

In some embodiments, the motherboard further includes:
a second line transfer switch, wherein three terminals of the second line transfer switch are connected to the communication transmission interface, the first line transfer switch, and the baseboard management controller, respectively.

In some embodiments, the motherboard further includes:
a first switch, a second switch, and a first power supply, wherein
the first switch is connected to the first power supply, the baseboard management controller, and the baseboard management controller memory; and
the second switch is connected to the communication transmission interface and the baseboard management controller.

In a third aspect, some embodiments of the present application provide an apparatus for burning firmware, the apparatus including:
a first switching module, configured to switch a first line transfer switch of a motherboard to connect a communication transmission interface of the motherboard to a baseboard management controller memory of the motherboard, wherein the first line transfer switch is configured to switch connection of the baseboard management controller memory to a baseboard management controller, or connection of the baseboard management controller memory to the communication transmission interface;
a burning module, configured to burn a firmware file into the baseboard management controller memory through the communication transmission interface and the first line transfer switch; and
a second switching module, configured to switch the first line transfer switch to connect the baseboard management controller to the baseboard management controller memory, so that the baseboard management controller calls the firmware file in the baseboard management controller memory.

In some embodiments, a second line transfer switch is provided on a connection line between the communication transmission interface and the baseboard management controller memory, and the first switching module includes:
a first switching sub-module, configured to switch the second line transfer switch of the motherboard to connect the communication transmission interface to the first line transfer switch, wherein the second line transfer switch is configured to switch the connection of the communication transmission interface to the baseboard management controller, or the connection of the communication transmission interface to the first line transfer switch; and
a second switching sub-module, configured to switch the first line transfer switch to connect the baseboard management controller memory to the second line transfer switch, wherein the first line transfer switch is configured to switch the connection of the baseboard management controller memory to the baseboard management controller, or the connection of the baseboard management controller memory to the second line transfer switch.

In some embodiments, a second line transfer switch is provided on a connection line between the communication transmission interface and the baseboard management controller memory, and the second switching module includes:
a third switching sub-module, configured to switch the second line transfer switch to connect the communication transmission interface to the baseboard management controller, wherein the second line transfer switch is configured to switch the connection of the communication transmission interface to the baseboard management controller, or the connection of the communication transmission interface to the first line transfer switch; and
a fourth switching sub-module, configured to switch the first line transfer switch to connect the baseboard management controller memory to the baseboard management controller, wherein the first line transfer switch is configured to switch the connection of the baseboard management controller memory to the baseboard management controller, or the connection of the baseboard management controller memory to the second line transfer switch.

In some embodiments, the apparatus further includes:
a turn-off module, configured to turn off a first switch corresponding to a first power supply, wherein the first power supply and the first switch are located on the motherboard, and the first power supply is configured to supply power to the baseboard management controller and the baseboard management controller memory through the first switch; and
a turn-on module, configured to turn on a second switch, wherein the second switch is configured to allow an external power supply to supply power to the baseboard management controller memory through the communication transmission interface.

In some embodiments, the apparatus further includes:
a first sending module, configured to send a first indicator signal to the baseboard management controller in response to the first line transfer switch connecting the baseboard management controller memory to the second line transfer switch, wherein the first indicator signal is configured to turn on a red indicator lamp corresponding to the baseboard management controller.

In some embodiments, the first sending module includes:
an obtaining sub-module, configured to obtain a connection state of the second line transfer switch; and
a first sending sub-module, configured to send the first indicator signal to the baseboard management controller in response to the connection state indicating that the second line transfer switch connects the communication transmission interface to the first line transfer switch.

In some embodiments, the second switching module includes:
a fifth switching sub-module, configured to switch the first line transfer switch to connect the baseboard management controller to the baseboard management controller memory; and
a second sending sub-module, configured to send a second indicator signal to the baseboard management controller, wherein the second indicator signal is configured to turn off a red indicator lamp corresponding to the baseboard management controller.

In some embodiments, the burning module includes:
a display sub-module, configured to display first switching information of the first line transfer switch, wherein the first switching information is configured to prompt a user to connect a burner for the firmware file to the communication transmission interface; and
a first burning sub-module, configured to burn the firmware file into the baseboard management controller memory through the communication transmission interface and the first line transfer switch when the burner is connected to the communication transmission interface.

In some embodiments, the burning module 602 includes:
a format conversion sub-module, configured to perform format conversion on the firmware file to obtain a programming file corresponding to the firmware file; and
a second burning sub-module, configured to burn the programming file into the baseboard management controller memory through the communication transmission interface and the first line transfer switch.

In a fourth aspect, the present application provides an electronic device, including a processor and a memory, wherein the memory stores programs or instructions executable on the processor, and the programs or instructions, when executed by the processor, implement the method for burning firmware according to any one of the above embodiments.

In a fifth aspect, some embodiments of the present application provide a system for burning firmware, including a terminal device and the motherboard according to any one of the above embodiments, wherein the terminal device includes a processor and a memory, the memory stores programs or instructions executable on the processor, and the programs or instructions, when executed by the processor, implement the method for burning firmware according to any one of the above embodiments.

In a sixth aspect, some embodiments of the present application provide a non-transitory readable storage medium, storing programs or instructions that, when executed by a processor, implement the method for burning firmware according to any one of the above embodiments.

A method for burning firmware provided in some embodiments of the present application includes: switching a first line transfer switch of a motherboard to connect a communication transmission interface of the motherboard to a baseboard management controller memory of the motherboard, wherein the first line transfer switch is configured to switch the connection of the baseboard management controller memory to a baseboard management controller, or the connection of the baseboard management controller memory to the communication transmission interface; burning a firmware file into the baseboard management controller memory through the communication transmission interface and the first line transfer switch; and switching the first line transfer switch to connect the baseboard management controller to the baseboard management controller memory, so that the baseboard management controller calls the firmware file in the baseboard management controller memory, whereby the baseboard management controller memory may be directly burned through the communication transmission interface of the baseboard management controller, avoiding disassembly of the baseboard management controller memory and reducing time and labor costs of repairing the baseboard management controller memory to a certain extent.

### BRIEF DESCRIPTION OF THE DRAWINGS

FIG. 1 is a flow chart of steps of a method for burning firmware according to some embodiments of the present application;

FIG. 2 is a flowchart of steps of another method for burning firmware according to some embodiments of the present application;

FIG. 3 is a schematic diagram of a component structure for a method for burning firmware according to some embodiments of the present application;

FIG. 4 is a schematic diagram of a hardware structure of a motherboard according to some embodiments of the present application;

FIG. 5 is a schematic structural diagram of a motherboard corresponding to a method for burning firmware according to some embodiments of the present application;

FIG. 6 is a logic block diagram of an apparatus for burning firmware according to some embodiments of the present application; and

FIG. 7 is a schematic structural diagram of an electronic device according to some embodiments of the present application.

### DETAILED DESCRIPTION

Below, the technical solutions in some embodiments of the present application will be clearly described in conjunction with the accompanying drawings. Obviously, the described embodiments are a part of the embodiments of the present application, not all of them. Based on some embodiments in the present application, all other embodiments obtained by those skilled in the art are within the scope of protection of the present application.

The terms “first”, “second”, etc. in the specification and claims of the present application are used to distinguish similar objects and not to describe a specific order or sequence. It should be understood that the data used in this way may be interchanged in appropriate circumstances, so that the embodiments of the present application may be implemented in an order other than those illustrated or described herein, and the objects distinguished by “first”, “second”, etc. are usually of the same class, without limiting the number of objects, for example, the first object may be one or multiple. In addition, in the specification and claims, “and/or” represents at least one of the connected objects, and the character “/” generally indicates a “or” relationship between the related objects.

Below, with reference to the accompanying drawings, we will provide a detailed explanation of the method for burning firmware provided in some embodiments of the present application through specific implementation examples and their application scenarios.

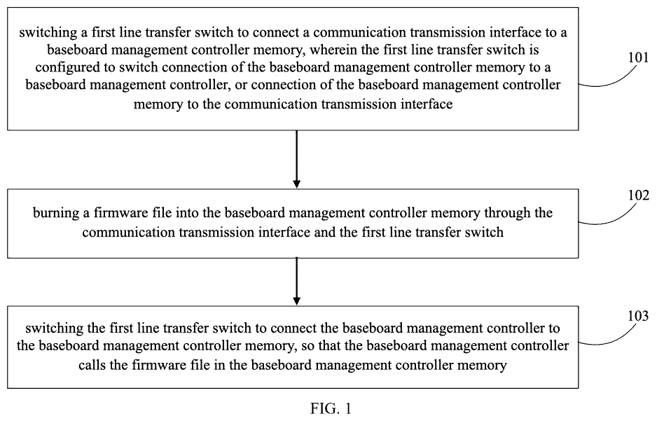

Referring to FIG. 1, FIG. 1 illustrates a flow chart of steps of a method for burning firmware according to some embodiments of the present application. The method for burning firmware may run on a terminal device such as a computer or a burner. The method may include the following steps:

Step 101, switching a first line transfer switch of a motherboard to connect a communication transmission interface of the motherboard to a baseboard management controller memory of the motherboard, wherein the first line transfer switch is configured to switch connection of the baseboard management controller memory to a baseboard management controller, or connection of the baseboard management controller memory to the communication transmission interface.

In some embodiments of the present application, the baseboard management controller may be mounted with a baseboard management controller memory component, and the baseboard management controller memory component may store programming files or firmware files, enabling the baseboard management controller to implement the functions specified in the programming files or firmware files. The baseboard management controller may communicate with an external device through the communication transmission interface, for example, transmit log files to the external device, or operate a server device connected to the baseboard management controller in response to instructions of the external device. Generally, the programming files or firmware files are transmitted into the baseboard management controller memory component through burning to be effective. Burning refers to transmitting target data in a form of programming signals to a programmable device through dedicated software and hardware devices. These programming signals may change the electronic state inside the programmable device, thereby writing or modifying specific data. During the burning process, a programming firmware or software tool is usually used to interact with a target device. The programming firmware or software tool converts the target data into specific programming signals and transmit them to the target device through a communication interface. The target device receiving the programming signals writes data into a storage unit inside the device according to the instructions of the signals, so as to update or modify data. Different burning technologies and programming interfaces have different working principles. In some embodiments of the present application, the communication transmission interface may be an RS232 DB9 port interface with pins 1 to 9, and the programming interface may be a Serial Peripheral Interface (SPI) with 5 transmission lines. The 5 transmission lines of the serial peripheral interface may be soldered onto pins 1 to 5 of the DB9 port interface. The corresponding relationship between the RS232 pins and the transmission lines of the serial peripheral interface is shown in the following table:

RS232 and SPI pin
corresponding table

| Pin | | |
|---|---|---|
| number | RS232 | SPI |
| 1 | DCD | VCC |
| 2 | RXD | CLK |
| 3 | TXD | MISO |
| 4 | DTR | MOSI |
| 5 | GND | GND |
| 6 | DSR | |
| 7 | RTS | |
| 8 | CTS | |
| 9 | RI | |

In some embodiments of the present application, in order to prevent the original communication function of the RS232 interface and the burning function of the serial peripheral interface from confusion and errors, an SPI bus and a first line transfer switch may be added between the RS232 interface as the communication transmission interface and the baseboard management controller memory, among them, the first line transfer switch is configured to switch the connection of the baseboard management controller memory to the baseboard management controller, or the connection of the baseboard management controller memory to the communication transmission interface. When the baseboard management controller memory is connected to the baseboard management controller, the baseboard management controller may access the firmware files or programming files in the baseboard management controller memory to run various functions of the baseboard management controller. When the baseboard management controller memory is connected to the communication transmission interface, the communication line between the baseboard management controller and the baseboard management controller memory is cut off, and a firmware file may be burned into the baseboard management controller memory through the SPI bus from the communication transmission interface.

In some embodiments of the present application, a first terminal may switch the first line transfer switch to connect the communication transmission interface and the baseboard management controller memory. The baseboard management controller may be disconnected from the baseboard management controller memory while switching the first line transfer switch to connect the communication transmission interface and the baseboard management controller memory. In addition, the communication transmission interface may be other integrated interfaces besides RS232, such as RS485 type interfaces. The embodiments of the present application do not limit it.

Step 102, burning a firmware file into the baseboard management controller memory through the communication transmission interface and the first line transfer switch.

In some embodiments of the present application, after the first line transfer switch is switched to connect the baseboard management controller memory and the communication transmission interface, the firmware file used for burning may be burned into the baseboard management controller memory with a burning tool through the communication transmission interface, the first line transfer switch, and the corresponding transmission lines.

Step 103, switching the first line transfer switch to connect the baseboard management controller to the baseboard management controller memory, so that the baseboard management controller calls the firmware file in the baseboard management controller memory.

In some embodiments of the present application, according to the implementation content of step 101, after the burning is completed, the baseboard management controller and the baseboard management controller memory may be in a disconnected state. At this time, the first line transfer switch may be switched to connect the baseboard management controller and the baseboard management controller memory. When the first line transfer switch is switched to connect the baseboard management controller to the baseboard management controller memory, the baseboard management controller memory may be disconnected from the communication transmission interface at the same time. After the connection between the baseboard management controller memory and the baseboard management controller is restored, the baseboard management controller may call the firmware file in the baseboard management controller memory, thereby realizing various functions of the baseboard management controller.

In some embodiments of the present application, the first line transfer switch of the motherboard is switched to connect the communication transmission interface of the motherboard to the baseboard management controller memory of the motherboard; among them, the first line transfer switch is configured to switch the connection of the baseboard management controller memory to the baseboard management controller, or the connection of the baseboard management controller memory to the communication transmission interface; the firmware file is burned into the baseboard management controller memory through the communication transmission interface and the first line transfer switch; and the first line transfer switch is switched to connect the baseboard management controller and the baseboard management controller memory, so that the baseboard management controller calls the firmware file in the baseboard management controller memory, whereby the baseboard management controller memory may be directly burned through the communication transmission interface of the baseboard management controller, avoiding the disassembly of the baseboard management controller memory and reducing the time and labor costs of repairing the baseboard management controller memory to a certain extent.

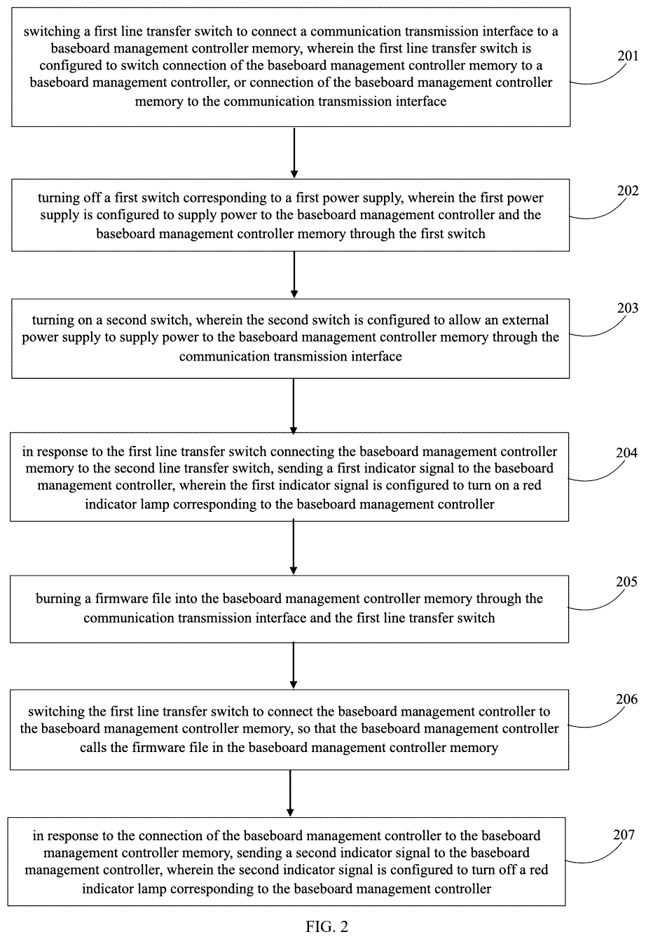

Referring to FIG. 2, FIG. 2 is a flow chart of steps of another method for burning firmware according to some embodiments of the present application. The method may include the following steps:

Step 201, switching a first line transfer switch of a motherboard to connect a communication transmission interface of the motherboard to a baseboard management controller memory of the motherboard, wherein the first line transfer switch is configured to switch the connection of the baseboard management controller memory to a baseboard management controller, or the connection of the baseboard management controller memory to the communication transmission interface.

In some embodiments of the present application, the implementation content of this step may refer to the implementation content of step 101, and will not be repeated here.

In some embodiments, step 201 may include the following sub-steps:

Sub-step 2011, switching a second line transfer switch of the motherboard to connect the communication transmission interface to the first line transfer switch, wherein the second line transfer switch is configured to switch the connection of the communication transmission interface to the baseboard management controller, or the connection of the communication transmission interface to the first line transfer switch.

In some embodiments of the present application, there may be the second line transfer switch on the transmission line between the first line transfer switch and the communication transmission interface, wherein the second line transfer switch may be configured to switch the connection of the communication transmission interface to the baseboard management controller, or the connection of the communication transmission interface to the first line transfer switch, that is, the second line transfer switch may be disposed on the transmission line between the communication transmission interface and the baseboard management controller, and a transmission line may be built between the first line transfer switch and the second line transfer switch. In this way, the baseboard management controller memory may be connected to the communication transmission interface through the first line transfer switch and the second line transfer switch. During the normal use of the baseboard management controller, the second line transfer switch may connect the communication transmission interface and the baseboard management controller, enabling the baseboard management controller to communicate with an external device. In some embodiments of the present application, the second line transfer switch may be switched to connect the communication transmission interface to the first line transfer switch and disconnect the communication transmission interface from the baseboard management controller.

Sub-step 2012, switching the first line transfer switch to connect the baseboard management controller memory to the second line transfer switch, wherein the first line transfer switch is configured to switch the connection of the baseboard management controller memory to the baseboard management controller, or the connection of the baseboard management controller memory to the second line transfer switch.

In some embodiments of the present application, the first line transfer switch is configured to switch the connection of the baseboard management controller memory to the baseboard management controller, or the connection of the baseboard management controller memory to the second line transfer switch. In some embodiments of the present application, the first line transfer switch may be switched to connect the baseboard management controller memory to the second line transfer switch and disconnect the baseboard management controller from the baseboard management controller memory.

In some embodiments of the present application, after the switching of the second line transfer switch in sub-step 2011 and the switching of the first line transfer switch in sub-step 2012, the communication transmission interface may be connected to the baseboard management controller memory, so that the baseboard management controller memory may directly communicate with the external device.

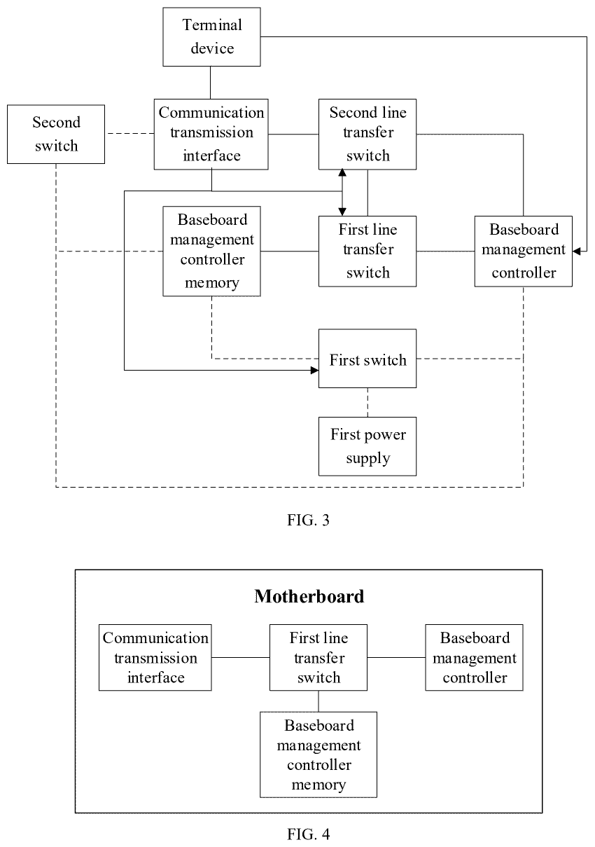

For example, as shown in FIG. 3, FIG. 3 is a schematic diagram of a component structure for a method for burning firmware according to some embodiments of the present application. In FIG. 3, solid lines may represent signal transmission lines, and dashed lines may represent power supply lines. A terminal device may be directly connected to the communication transmission interface and may control the first line transfer switch and the second line transfer switch through the communication transmission interface. When the second line transfer switch connects the communication transmission interface to the baseboard management controller, or when the first line transfer switch connects the baseboard management controller memory to the baseboard management controller, the baseboard management controller memory cannot be directly connected to the communication transmission interface, and also cannot directly communicate with the terminal device through the communication transmission interface. Only when the second line transfer switch connects the communication transmission interface to the first line transfer switch, and the first line transfer switch connects the baseboard management controller memory to the second line transfer switch, the baseboard management controller may directly communicate with the terminal device through the communication transmission interface.

In some embodiments of the present application, the second line transfer switch of the motherboard is switched to connect the communication transmission interface to the first line transfer switch, among them, the second line transfer switch is configured to switch the connection of the communication transmission interface to the baseboard management controller, or the connection of the communication transmission interface to the first line transfer switch; and the first line transfer switch is switched to connect the baseboard management controller memory to the second line transfer switch, among them, the first line transfer switch is configured to switch the connection of the baseboard management controller memory to the baseboard management controller, or the connection of the baseboard management controller memory to the second line transfer switch, so that the baseboard management controller memory may be connected to the communication transmission interface through the first line transfer switch and the second line transfer switch, and the baseboard management controller memory may be disconnected from the communication transmission interface and the baseboard management controller, avoiding logic confusion and errors that may occur during the burning process, and improving the reliability and security of the method for burning firmware.

Step 202, turning off a first switch corresponding to a first power supply, wherein the first power supply and the first switch are located on the motherboard, and the first power supply is configured to supply power to the baseboard management controller and the baseboard management controller memory through the first switch.

In some embodiments of the present application, the first switch may be connected to the first power supply, the baseboard management controller, and the baseboard management controller memory, and the first power supply may supply power to the baseboard management controller and the baseboard management controller memory when the first switch is turned on. The first power supply may be a direct current stabilized power supply, and its voltage value may be adjusted according to a rated voltage of the baseboard management controller. When the baseboard management controller memory is connected to the communication transmission interface, the first switch may be turned off, so that the first power supply stops supplying power to the baseboard management controller memory and the baseboard management controller.

Step 203, turning on a second switch, wherein the second switch is configured to allow an external power supply to supply power to the baseboard management controller memory through the communication transmission interface.

In some embodiments of the present application, the terminal device connected to the communication transmission interface may be mounted with the external power supply, which may supply power to the baseboard management controller memory through the second switch. The second switch may be turned on, so that the external power supply mounted on the terminal device supplies power to the baseboard management controller memory through the communication transmission interface. After supplying power to the baseboard management controller memory, the terminal device may recognize the baseboard management controller memory.

Following the above example, in FIG. 3, the terminal device may control the first switch to turn off and then control the second switch to turn on, so that the terminal device may supply power to the baseboard management controller memory.

In some embodiments of the present application, the first switch corresponding to the first power supply is turned off, among them, the first power supply is configured to supply power to the baseboard management controller and the baseboard management controller memory through the first switch; and the second switch is turned on, among them, the second switch is configured to allow the external power supply to supply power to the baseboard management controller memory through the communication transmission interface, whereby the power supply of the system may be changed before a firmware file is burned, avoiding power supply hazards inside the system and improving the usability and stability of the method for burning firmware.

Step 204, in response to the first line transfer switch connecting the baseboard management controller memory to the second line transfer switch, sending a first indicator signal to the baseboard management controller, wherein the first indicator signal is configured to turn on a red indicator lamp corresponding to the baseboard management controller.

In some embodiments of the present application, the red indicator lamp may be mounted on the baseboard management controller. When the first line transfer switch connects the baseboard management controller memory to the second line transfer switch, the first indicator signal may be sent to the baseboard management controller to turn on the red indicator lamp on the baseboard management controller.

In some embodiments, step 204 may include the following sub-steps:

Sub-step 2041, obtaining a connection state of the second line transfer switch.

In some embodiments of the present application, when the first line transfer switch connects the baseboard management controller memory to the second line transfer switch, the connection state of the second line transfer switch may be obtained to determine whether the second line transfer switch connects the communication transmission interface to the baseboard management controller or connects the communication transmission interface to the first line transfer switch.

Sub-step 2042, when the connection state indicates that the second line transfer switch connects the communication transmission interface to the first line transfer switch, sending the first indicator signal to the baseboard management controller.

In some embodiments of the present application, when the second line transfer switch connects the communication transmission interface to the first line transfer switch, the first indicator signal may be sent to the baseboard management controller, thereby lighting up the red indicator lamp.

In some embodiments of the present application, by obtaining the connection state of the second line transfer switch and sending the first indicator signal to the baseboard management controller when the connection state indicates that the second line transfer switch connects the communication transmission interface to the first line transfer switch, the corresponding indicator lamp may be turned on when the baseboard management controller memory is directly connected to the communication transmission interface through the first line transfer switch and the second line transfer switch, further improving the practicality of the method for burning firmware.

In some embodiments of the present application, when the first line transfer switch connects the baseboard management controller memory to the second line transfer switch, the first indicator signal is sent to the baseboard management controller, wherein the first indicator signal is configured to turn on the red indicator lamp corresponding to the baseboard management controller, whereby the corresponding indicator lamp may be turned on when the baseboard management controller is directly connected to the communication transmission interface, improving the practicality of the method for burning firmware.

Step 205, burning a firmware file into the baseboard management controller memory through the communication transmission interface and the first line transfer switch.

In some embodiments of the present application, the implementation content of this step may refer to the implementation content of step 102, and will not be repeated here.

In some embodiments, step 205 may include the following sub-steps:

Sub-step 2051: displaying first switching information of the first line transfer switch, wherein the first switching information is configured to prompt a user to connect a burner for the firmware file to the communication transmission interface.

In some embodiments of the present application, when the first line transfer switch is switched to the state of connecting the baseboard management controller memory to the communication transmission interface, the first switching information of the first line transfer switch may be generated and displayed to display, to the user, the connection state of the first line transfer switch after switching and prompt the user to connect the burner to the communication transmission interface.

Sub-step 2052, when the burner is connected to the communication transmission interface, burning the firmware file into the baseboard management controller memory through the communication transmission interface and the first line transfer switch.

In some embodiments of the present application, after connecting the burner to the communication transmission interface, the user may use the burner to burn the firmware file into the baseboard management controller memory through the communication transmission interface and the first line transfer switch.

In some embodiments of the present application, the first switching information of the first line transfer switch is displayed, wherein the first switching information is configured to prompt the user to connect the burner for the firmware file to the communication transmission interface; and when the burner is connected to the communication transmission interface, the firmware file is burned into the baseboard management controller memory through the communication transmission interface and the first line transfer switch, which may prompt the user to connect the burner for burning, improving the usability of the method for burning firmware.

Sub-step 2053, performing format conversion on the firmware file to obtain a programming file corresponding to the firmware file.

In some embodiments of the present application, the firmware file may be a program file formed based on a programming language, and is used to drive the baseboard management controller or upgrade a driver of the baseboard management controller. Generally, code in this firmware file cannot be directly recognized by a machine, but needs to be format-converted into a programming file that may be directly recognized by the machine. In some embodiments of the present application, when the format of the firmware file does not match the format of programming files that the machine may recognize, the firmware file may be format-converted to obtain a programming file that corresponds to the firmware file and may be directly recognized by the machine.

For example, when the format of the firmware file is “.c”, the “.c” file may be converted into a program file format that may be directly recognized and called by a hardware device, such as a “.hex” file. The file obtained after the format conversion is the programming file.

Sub-step 2054, burning the programming file into the baseboard management controller memory through the communication transmission interface and the first line transfer switch.

In some embodiments of the present application, after the format conversion of the firmware file to obtain the programming file, the programming file may be burned into the baseboard management controller memory through the communication transmission interface and the first line transfer switch by means of the terminal device or burner connected to the communication transmission interface.

In some embodiments of the present application, by performing format conversion on the firmware file to obtain the programming file corresponding to the firmware file, and burning the programming file into the baseboard management controller memory through the communication transmission interface and the first line transfer switch, the firmware file may be converted into the programming file that the hardware device may directly recognize, improving the usability of the firmware file.

Step 206, switching the first line transfer switch to connect the baseboard management controller to the baseboard management controller memory, so that the baseboard management controller calls the firmware file in the baseboard management controller memory.

In some embodiments of the present application, the implementation content of this step may refer to the implementation content of step 103, and will not be repeated here.

In some embodiments, step 206 may include the following sub-steps:

Sub-step 2061, switching the second line transfer switch to connect the communication transmission interface to the baseboard management controller, wherein the second line transfer switch is configured to switch the connection of the communication transmission interface to the baseboard management controller, or the connection of the communication transmission interface to the first line transfer switch.

In some embodiments of the present application, the connection relationship of the second line transfer switch may be the same as that of the second line transfer switch in step 2011. The connection relationship of the second line transfer switch may refer to the implementation content in step 2011. After the burning is completed, the second line transfer switch may be switched to reconnect the communication transmission interface to the baseboard management controller, thereby restoring the communication between the baseboard management controller and the external device.

Sub-step 2062, switching the first line transfer switch to connect the baseboard management controller memory to the baseboard management controller, wherein the first line transfer switch is configured to switch the connection of the baseboard management controller memory to the baseboard management controller, or the connection of the baseboard management controller memory to the second line transfer switch.

In some embodiments of the present application, the connection relationship of the first line transfer switch may be the same as that of the first line transfer switch in step 2012, and relevant content may refer to the implementation content of step 2012. After the switching of the second line transfer switch is completed, the first line transfer switch may be switched to connect the baseboard management controller memory to the baseboard management controller, thereby restoring the communication between the baseboard management controller and the baseboard management controller memory.

For example, in the hardware structure shown in FIG. 3, the second line transfer switch may be switched to connect the communication transmission interface to the baseboard management controller, and the first line transfer switch may be switched to connect the baseboard management controller to the baseboard management controller memory. In this way, the second line transfer switch and the first line transfer switch are in an off state, and the terminal device may directly access the baseboard management controller through the communication transmission interface, but cannot directly access the baseboard management controller memory through the communication transmission interface.

In some embodiments of the present application, the second line transfer switch is switched to connect the communication transmission interface to the baseboard management controller, wherein the second line transfer switch is configured to switch the connection of the communication transmission interface to the baseboard management controller, or the connection of the communication transmission interface to the first line transfer switch; and the first line transfer switch is switched to connect the baseboard management controller memory to the baseboard management controller, wherein the first line transfer switch is configured to switch the connection of the baseboard management controller memory to the baseboard management controller, or the connection of the baseboard management controller memory to the second line transfer switch, whereby the normal communication of the baseboard management controller may be restored by switching the second line transfer switch and the first line transfer switch after the burning is completed, improving the practicality of the method for burning firmware.

Step 207, in response to the connection of the baseboard management controller to the baseboard management controller memory, sending a second indicator signal to the baseboard management controller, wherein the second indicator signal is configured to turn off a red indicator lamp corresponding to the baseboard management controller.

In some embodiments of the present application, when the first line transfer switch connects the baseboard management controller to the baseboard management controller memory, the second indicator signal may be sent to the baseboard management controller. The second indicator signal may be configured to turn off the red indicator lamp corresponding to the baseboard management controller.

In some embodiments of the present application, when the baseboard management controller is connected to the baseboard management controller memory, the second indicator signal is sent to the baseboard management controller, wherein the second indicator signal is configured to turn off the red indicator lamp corresponding to the baseboard management controller, whereby the connection state of the first line transfer switch may be confirmed by the turn-off of the red indicator lamp, improving the practicality of the method for burning firmware.

In some embodiments of the present application, another method for burning firmware may be provided. Firstly, a computer may be connected to the communication transmission interface, and then a burning tool may be run in the computer. The burning tool may recognize hardware connected to the computer and control the hardware to perform various operations. The burning tool may control the second line transfer switch to connect the communication transmission interface to the first line transfer switch, and may also control the first line transfer switch to connect the baseboard management controller memory to the second line transfer switch. Afterwards, the burning tool may recognize the baseboard management controller memory, including the corresponding identifier and size of the memory. Subsequently, the burning tool may erase original data in the baseboard management controller memory, format a firmware file, and then burn the firmware file into the baseboard management controller memory to complete the burning. After the burning succeeds, the burning tool may control the first line transfer switch and the second line transfer switch to restore to their initial state, thereby disconnecting from the baseboard management controller memory. In this way, the burning of the baseboard management controller memory may be completed without disassembling the baseboard management controller memory.

Referring to FIG. 4, FIG. 4 is a schematic structural diagram of a motherboard according to some embodiments of the present application, the motherboard including:
a baseboard management controller memory, a first line transfer switch, a communication transmission interface, and a baseboard management controller, wherein
the first line transfer switch is configured to connect the communication transmission interface, the baseboard management controller, and the baseboard management controller memory.

The motherboard provided in some embodiments of the present application may use the method for burning firmware in the embodiment of steps 101 to 103, where the first line transfer switch is switched to connect the communication transmission interface to the baseboard management controller memory, then the baseboard management controller memory may be burned through a terminal device, and finally the first line transfer switch may be switched to connect the baseboard management controller to the baseboard management controller memory.

In some embodiments, the motherboard further includes:
a second line transfer switch, wherein three terminals of the second line transfer switch are connected to the communication transmission interface, the first line transfer switch, and the baseboard management controller, respectively.

In some embodiments, the motherboard further includes:
a first switch, a second switch, and a first power supply, wherein
the first switch is connected to the first power supply, the baseboard management controller, and the baseboard management controller memory; and
the second switch is connected to the communication transmission interface and the baseboard management controller.

In summary, some embodiments of the present application provide a motherboard, including a baseboard management controller memory, a first line transfer switch, a communication transmission interface, and a baseboard management controller, which may implement each process in the method embodiments shown in FIG. 1 and FIG. 2. To avoid repetition, details will not be repeated here.

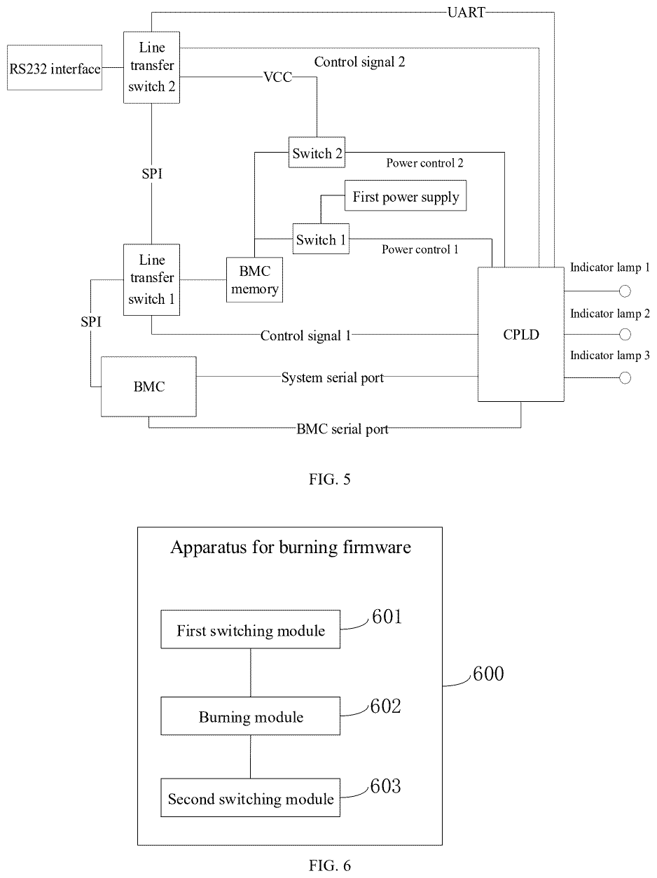

Referring to FIG. 5. FIG. 5 is a schematic structural diagram of a motherboard corresponding to a method for burning firmware according to some embodiments of the present application. In the figure, an RS232 interface may be soldered to an SPI bus; a CPLD may be connected to a BMC, a line transfer switch 1, a line transfer switch 2, an indicator lamp 1, an indicator lamp 2, an indicator lamp 3, a switch 1, and a switch 2; and the CPLD may communicate with the BMC through a system serial port and a BMC serial port. In a normal state, the indicator lamp 1 is constantly on, while the indicator lamp 2 and the indicator lamp 3 are off. When the BMC memory needs to be burned, an external device may send a burning instruction signal to the CPLD over a Universal Asynchronous Receiver/Transmitter (UART) line through the RS232 interface. In response to the burning instruction signal, the CPLD may switch the line transfer switch 1 through a control signal line 1 to connect the BMC memory to the line transfer switch 2 through an SPI bus, at this time, the indicator lamp 1 may be turned off, and the indicator lamp 2 may be turned on. Then, the CPLD may switch the line transfer switch 2 through a control signal line 2 to connect the RS232 interface to the line transfer switch 1 through the SPI bus, at this time, the indicator lamp 2 may be turned off, and the indicator lamp 3 may be turned on, indicating that the switching between the line transfer switch 1 and the line transfer switch 2 is completed and burning may be performed. The CPLD may also disconnect the switch 1 through a power control line 1 and connect the switch 2 through a power control line 2 to switch the power supply of the system from a first power supply to an external power supply. After the burning is completed, the CPLD may control the line transfer switch 1 and the line transfer switch 2 to restore to their initial state, at this time, the indicator lamp 3 is turned off, and the indicator lamp 1 is turned on. In addition, the CPLD may also disconnect the switch 2 and connect the switch 1 to switch the power supply of the system from the external device back to the first power supply. In this way, one process of burning the BMC memory is completed.

Referring to FIG. 6, FIG. 6 is a logic block diagram of an apparatus for burning firmware according to some embodiments of the present application. The apparatus for burning firmware 600 includes:
a first switching module 601, configured to switch a first line transfer switch of a motherboard to connect a communication transmission interface of the motherboard to a baseboard management controller memory of the motherboard, wherein the first line transfer switch is configured to switch the connection of the baseboard management controller memory to a baseboard management controller, or the connection of the baseboard management controller memory to the communication transmission interface;
a burning module 602, configured to burn a firmware file into the baseboard management controller memory through the communication transmission interface and the first line transfer switch; and
a second switching module 603, configured to switch the first line transfer switch to connect the baseboard management controller to the baseboard management controller memory, so that the baseboard management controller calls the firmware file in the baseboard management controller memory.

In some embodiments, a second line transfer switch is provided on a connection line between the communication transmission interface and the baseboard management controller memory, and the first switching module 601 includes:
a first switching sub-module, configured to switch the second line transfer switch of the motherboard to connect the communication transmission interface to the first line transfer switch, wherein the second line transfer switch is configured to switch the connection of the communication transmission interface to the baseboard management controller, or the connection of the communication transmission interface to the first line transfer switch; and
a second switching sub-module, configured to switch the first line transfer switch to connect the baseboard management controller memory to the second line transfer switch, wherein the first line transfer switch is configured to switch the connection of the baseboard management controller memory to the baseboard management controller, or the connection of the baseboard management controller memory to the second line transfer switch.

In some embodiments, a second line transfer switch is provided on a connection line between the communication transmission interface and the baseboard management controller memory, and the second switching module 603 includes:
a third switching sub-module, configured to switch the second line transfer switch to connect the communication transmission interface to the baseboard management controller, wherein the second line transfer switch is configured to switch the connection of the communication transmission interface to the baseboard management controller, or the connection of the communication transmission interface to the first line transfer switch; and
a fourth switching sub-module, configured to switch the first line transfer switch to connect the baseboard management controller memory to the baseboard management controller, wherein the first line transfer switch is configured to switch the connection of the baseboard management controller memory to the baseboard management controller, or the connection of the baseboard management controller memory to the second line transfer switch.

In some embodiments, the apparatus 600 further includes:
a turn-off module, configured to turn off a first switch corresponding to a first power supply, wherein the first power supply and the first switch are located on the motherboard, and the first power supply is configured to supply power to the baseboard management controller and the baseboard management controller memory through the first switch; and
a turn-on module, configured to turn on a second switch, wherein the second switch is configured to allow an external power supply to supply power to the baseboard management controller memory through the communication transmission interface.

In some embodiments, the apparatus 600 further includes:
a first sending module, configured to send a first indicator signal to the baseboard management controller when the first line transfer switch connects the baseboard management controller memory to the second line transfer switch, wherein the first indicator signal is configured to turn on a red indicator lamp corresponding to the baseboard management controller.

In some embodiments, the first sending module includes:
an obtaining sub-module, configured to obtain a connection state of the second line transfer switch; and
a first sending sub-module, configured to send the first indicator signal to the baseboard management controller when the connection state indicates that the second line transfer switch connects the communication transmission interface to the first line transfer switch.

In some embodiments, the second switching module 603 includes:
a fifth switching sub-module, configured to switch the first line transfer switch to connect the baseboard management controller to the baseboard management controller memory; and
a second sending sub-module, configured to send a second indicator signal to the baseboard management controller, wherein the second indicator signal is configured to turn off a red indicator lamp corresponding to the baseboard management controller.

In some embodiments, the burning module 602 includes:
a display sub-module, configured to display first switching information of the first line transfer switch, wherein the first switching information is configured to prompt a user to connect a burner for the firmware file to the communication transmission interface; and
a first burning sub-module, configured to burn the firmware file into the baseboard management controller memory through the communication transmission interface and the first line transfer switch when the burner is connected to the communication transmission interface.

In some embodiments, the burning module 602 includes:
a format conversion sub-module, configured to perform format conversion on the firmware file to obtain a programming file corresponding to the firmware file; and
a second burning sub-module, configured to burn the programming file into the baseboard management controller memory through the communication transmission interface and the first line transfer switch.

In summary, some embodiments of the present application provide an apparatus for burning firmware, including: a first switching module, configured to switch a first line transfer switch of a motherboard to connect a communication transmission interface of the motherboard to a baseboard management controller memory of the motherboard, wherein the first line transfer switch is configured to switch the connection of the baseboard management controller memory to a baseboard management controller, or the connection of the baseboard management controller memory to the communication transmission interface; a burning module, configured to burn a firmware file into the baseboard management controller memory through the communication transmission interface and the first line transfer switch; and a second switching module, configured to switch the first line transfer switch to connect the baseboard management controller to the baseboard management controller memory, so that the baseboard management controller calls the firmware file in the baseboard management controller memory, whereby the baseboard management controller memory may be directly burned through the communication transmission interface of the baseboard management controller, avoiding the disassembly of the baseboard management controller memory and reducing the time and labor costs of repairing the baseboard management controller memory to a certain extent.

The apparatus for burning firmware in some embodiments of the present application may be an electronic device or a component in an electronic device, such as an integrated circuit. The electronic device may be a terminal or other devices besides the terminal. For example, the electronic device may be a GPU BOX, a mobile phone, a tablet, a laptop, a palm computer, a vehicle-mounted electronic device, a Mobile Internet Device (MID), an augmented reality (AR)/virtual reality (VR) device, a robot, a wearable device, an ultra-mobile personal computer (UMPC), a netbook, a personal digital assistant (PDA), a server, a Network Attached Storage (NAS), a personal computer (PC), a television (TV), an automated teller machine, a self-service machine, or the like. The embodiments of the present application do not limit it.

The apparatus for burning firmware in some embodiments of the present application may be an apparatus with an operating system. The operating system may be an Android operating system, a Linux or Windows operating system, or any other possible operating system. The embodiments of the present application do not limit it.

The apparatus for burning firmware according to some embodiments of the present application may implement each process implemented in the method embodiments shown in FIG. 1 and FIG. 2. To avoid repetition, details are not further described herein.

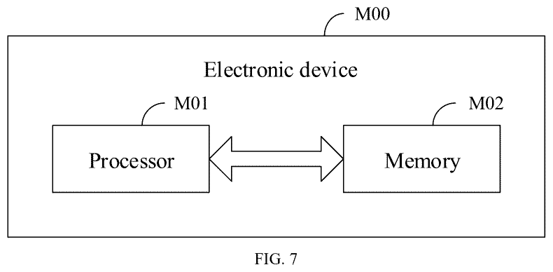

In some embodiments, as shown in FIG. 7, some embodiments of the present application further provide an electronic device M00, including a processor M01 and a memory M02, where the memory M02 stores programs or instructions executable on the processor M01, and the programs or instructions, when executed by the processor M01, implement each step of the method for burning firmware in the above embodiments and may achieve the same technical effects. To avoid repetition, details are not further described herein.

It should be noted that the electronic device in some embodiments of the present application includes the above mobile electronic devices and non-mobile electronic devices.

Some embodiments of the present application further provide a system for burning firmware. The system includes a terminal device and the above motherboard, where the terminal device includes a processor and a memory, the memory stores programs or instructions executable on the processor, and the programs or instructions, when executed by the processor, implement each step of the method for burning firmware in the above embodiments and may achieve the same technical effects. To avoid repetition, details are not further described herein.

Some embodiments of the present application further provide a non-transitory readable storage medium, storing programs or instructions that, when executed by a processor, implement each process of the method for burning firmware in the above embodiments and may achieve the same technical effects. To avoid repetition, details are not further described herein.

The processor is the processor in the electronic device in the above embodiments. The non-transitory readable storage medium includes non-transitory computer-readable storage media, such as a read-only memory (ROM), a random access memory (RAM), a magnetic disk, or an optical disk.

Some embodiments of the present application provide a computer program product stored in a storage medium, wherein the program product is executed by at least one processor to implement each process of the method for burning firmware in the above embodiments and may achieve the same technical effects. To avoid repetition, details are not further described herein.

It should be noted that in this article, the terms “including/comprising”, “containing” or any other variation thereof are intended to encompass non-exclusive inclusion, such that a process, method, article, or apparatus that includes a series of elements not only includes those elements, but also includes other elements not explicitly listed, or also includes elements inherent to such process, method, article, or apparatus. Without further limitations, the element limited by the statement “including one . . . ” does not exclude the existence of other identical elements in the process, method, article, or device that includes that element. In addition, it should be pointed out that the scope of the methods and devices in the embodiments of the present application is not limited to performing functions in the order shown or discussed, and may also include performing functions in a substantially simultaneous manner or in the opposite order according to the functions involved. For example, the described methods may be performed in a different order than described, and various steps may be added, omitted, or combined. Additionally, the features described with reference to certain examples may be combined in other examples.

Through the description of the above implementation methods, persons skilled in the art may clearly understand that the above implementation methods may be implemented through software and necessary general hardware platforms. Certainly, they may also be implemented through hardware, but in many cases, the former is the better implementation method. Based on this understanding, the technical solution of the present application may essentially or contribute to the relevant technology in the form of a computer software product, which is stored in a storage medium (such as ROM/RAM, magnetic disk, optical disk) and includes several instructions to enable a terminal (which may be a mobile phone, computer, server, or network device, etc.) to execute the methods of various embodiments of the present application.

The embodiments of the present application have been described above in conjunction with the accompanying drawings, but the present application is not limited to the specific embodiments described above. The specific embodiments described above are only illustrative and not restrictive. Those of ordinary skill in the art may also make many forms within the scope of protection of the present application without departing from the purpose and claims of the present application.

1. A method for burning firmware, comprising:
switching a first line transfer switch of a motherboard to connect a communication transmission interface of the motherboard to a baseboard management controller memory of the motherboard, wherein the first line transfer switch is configured to switch connection of the baseboard management controller memory to a baseboard management controller of the motherboard, or connection of the baseboard management controller memory to the communication transmission interface;
burning a firmware file into the baseboard management controller memory through the communication transmission interface and the first line transfer switch; and
switching the first line transfer switch to connect the baseboard management controller to the baseboard management controller memory, so that the baseboard management controller calls the firmware file in the baseboard management controller memory.

2. The method according to claim 1, wherein a second line transfer switch is provided on a connection line between the communication transmission interface and the baseboard management controller memory, and the switching a first line transfer switch of a motherboard to connect a communication transmission interface of the motherboard to a baseboard management controller memory of the motherboard comprises:
switching the second line transfer switch of the motherboard to connect the communication transmission interface to the first line transfer switch, wherein the second line transfer switch is configured to switch connection of the communication transmission interface to the baseboard management controller, or connection of the communication transmission interface to the first line transfer switch; and
switching the first line transfer switch to connect the baseboard management controller memory to the second line transfer switch, wherein the first line transfer switch is configured to switch the connection of the baseboard management controller memory to the baseboard management controller, or connection of the baseboard management controller memory to the second line transfer switch.

3. The method according to claim 2, wherein the method further comprises:
switching the second line transfer switch to connect the communication transmission interface to the first line transfer switch, and switching the first line transfer switch to connect the baseboard management controller memory to the second line transfer switch, so that the baseboard management controller memory communicates with an external device.

4. The method according to claim 1, wherein a second line transfer switch is provided on a connection line between the communication transmission interface and the baseboard management controller memory, and the switching the first line transfer switch to connect the baseboard management controller to the baseboard management controller memory comprises:
switching the second line transfer switch to connect the communication transmission interface to the baseboard management controller, wherein the second line transfer switch is configured to switch connection of the communication transmission interface to the baseboard management controller, or connection of the communication transmission interface to the first line transfer switch; and
switching the first line transfer switch to connect the baseboard management controller memory to the baseboard management controller, wherein the first line transfer switch is configured to switch the connection of the baseboard management controller memory to the baseboard management controller, or connection of the baseboard management controller memory to the second line transfer switch.

5. The method according to claim 4, wherein the method further comprises:
switching the second line transfer switch to connect the communication transmission interface to the baseboard management controller, so that the baseboard management controller communicates with an external device.

6. The method according to claim 2, wherein the method further comprises:
turning off a first switch corresponding to a first power supply, wherein the first power supply and the first switch are located on the motherboard, and the first power supply is configured to supply power to the baseboard management controller and the baseboard management controller memory through the first switch; and
turning on a second switch of the motherboard, wherein the second switch is configured to allow an external power supply to supply power to the baseboard management controller memory through the communication transmission interface.

7. The method according to claim 6, wherein the method further comprises:
adjusting a voltage value of the first power supply according to a rated voltage of the baseboard management controller.

8. The method according to claim 2, wherein the method further comprises:
in response to the first line transfer switch connecting the baseboard management controller memory to the second line transfer switch, sending a first indicator signal to the baseboard management controller, wherein the first indicator signal is configured to turn on a red indicator lamp corresponding to the baseboard management controller.

9. The method according to claim 8, wherein the sending a first indicator signal to the baseboard management controller comprises:
obtaining a connection state of the second line transfer switch; and
in response to the connection state indicating that the second line transfer switch connects the communication transmission interface to the first line transfer switch, sending the first indicator signal to the baseboard management controller.

10. The method according to claim 1, wherein the method further comprises:
in response to the connection of the baseboard management controller to the baseboard management controller memory, sending a second indicator signal to the baseboard management controller, wherein the second indicator signal is configured to turn off a red indicator lamp corresponding to the baseboard management controller.

11. The method according to claim 1, wherein the burning a firmware file into the baseboard management controller memory through the communication transmission interface and the first line transfer switch comprises:
displaying first switching information of the first line transfer switch, wherein the first switching information is configured to prompt a user to connect a burner for the firmware file to the communication transmission interface; and
in response to connection of the burner to the communication transmission interface, burning the firmware file into the baseboard management controller memory through the communication transmission interface and the first line transfer switch.

12. The method according to claim 11, wherein the displaying first switching information of the first line transfer switch comprises:
generating and displaying the first switching information in response to the first line transfer switch being switched to connect the baseboard management controller memory to the communication transmission interface.

13. The method according to claim 1, wherein the burning a firmware file into the baseboard management controller memory through the communication transmission interface and the first line transfer switch comprises:
performing format conversion on the firmware file to obtain a programming file corresponding to the firmware file; and
burning the programming file into the baseboard management controller memory through the communication transmission interface and the first line transfer switch.

14. A motherboard, comprising:
a baseboard management controller memory, a first line transfer switch, a communication transmission interface, and a baseboard management controller, wherein
the first line transfer switch is configured to connect the communication transmission interface, the baseboard management controller, and the baseboard management controller memory; and
the motherboard is configured to implement the method for burning firmware according to claim 1.

15. The motherboard according to claim 14, wherein the motherboard further comprises:
a second line transfer switch, wherein three terminals of the second line transfer switch are connected to the communication transmission interface, the first line transfer switch, and the baseboard management controller, respectively.

16. The motherboard according to claim 14, wherein the motherboard further comprises:
a first switch, a second switch, and a first power supply, wherein
the first switch is connected to the first power supply, the baseboard management controller, and the baseboard management controller memory; and
the second switch is connected to the communication transmission interface and the baseboard management controller.

17. (canceled)

18. An electronic device, comprising a processor and a memory, wherein the memory stores programs or instructions executable on the processor, and the programs or instructions, when executed by the processor, implement the method for burning firmware according to claim 1.

19. A system for burning firmware, comprising a terminal device and the motherboard according to claim 14, wherein the terminal device comprises a processor and a memory, the memory stores programs or instructions executable on the processor, and the programs or instructions, when executed by the processor, implement operations on the motherboard, wherein the operations comprise:
switching a first line transfer switch of the motherboard to connect a communication transmission interface of the motherboard to a baseboard management controller memory of the motherboard, wherein the first line transfer switch is configured to switch connection of the baseboard management controller memory to a baseboard management controller of the motherboard, or connection of the baseboard management controller memory to the communication transmission interface;
burning a firmware file into the baseboard management controller memory through the communication transmission interface and the first line transfer switch; and
switching the first line transfer switch to connect the baseboard management controller to the baseboard management controller memory, so that the baseboard management controller calls the firmware file in the baseboard management controller memory.

20. A non-transitory readable storage medium, storing programs or instructions that, when executed by a processor, implement the method for burning firmware according to claim 1.

21. The method according to claim 1, wherein the method further comprises:
disconnecting the baseboard management controller from the baseboard management controller memory while switching the first line transfer switch to connect the communication transmission interface and the baseboard management controller memory.
